(19) United States
(12) Patent Application Publication
(10) Pub. No.: US 2026/0017777 A1
(43) Pub. Date: Jan. 15, 2026

(54) DETERMINATION APPARATUS, TRAINING APPARATUS, DETERMINATION METHOD, TRAINING METHOD, DETERMINATION PROGRAM, AND TRAINING PROGRAM

(71) Applicant: Nitto Denko Corporation, Ibaraki-shi, Osaka (JP)

(72) Inventors: Ryosuke Hiramoto, Osaka (JP); Yoichi Kigawa, Osaka (JP); Asami Narukawa, Mie (JP)

(73) Assignee: Nitto Denko Corporation, Ibaraki-shi, Osaka (JP)

(21) Appl. No.: 19/137,478

(22) PCT Filed: Mar. 28, 2024
(86) PCT No.: PCT/JP2024/012806

§ 371 Date: Jun. 10, 2025

(30) Foreign Application Priority Data
Mar. 29, 2023 (JP) 2023-054110

(51) Int. Cl. G06T 7/00; G06T 11/40; G06T 11/60

(52) U.S. Cl. CPC G06T 7/001; G06T 11/40; G06T 11/60

(57) ABSTRACT

A determination apparatus includes a processor configured to: use a trained image generation AI-trained so as to reconstruct first image from first mask image in which mask is overlaid onto inspection region of the first image, the mask being colored according to types of material included in corresponding region of inspection target object and being configured to be overlaid onto the inspection region, the first image being image determined not to contain defect among captured images of the inspection target object; and compare second reconstruction image with second image to determine whether or not the second image contains defect, the second reconstruction image being reconstructed by inputting second mask image into the trained image generation AI, the second mask image being image in which the mask is overlaid on, and corresponds to, inspection region of the second image, the second image being captured image of the inspection target object.

### TECHNICAL FIELD

The present disclosure relates to a determination apparatus, a training apparatus, a determination method, a training method, a determination program, and a training program.

### BACKGROUND ART

There is a known inspection system in which a human inspector performs a visual inspection (i.e., visual inspection performed by looking directly at the image with the naked eye), on images determined to contain defects, among inspection images acquired by capturing images of inspection target objects such as printed circuit boards, in order to determine whether the inspection target object is a defect-free product or a defective product.

With this inspection system, image generation artificial intelligence (AI) or the like, that is trained so as to reconstruct normal images, for example, can be applied to make a determination as to whether or not the inspection image contains a defect.

With this image generation AI, a determination is made as to whether or not an inspection image is a normal image by reconstructing an image referred to as a reconstruction image from a masked inspection image created by overlaying a mask onto an inspection image, and then comparing the reconstruction image with the inspection image. Therefore, even if a new type of defect occurs, this image generation AI can make an appropriate determination.

### CITATION LIST

### Patent Literature

### Patent Literature 1: Unexamined Japanese Patent Application Publication No. 2022-114331

### SUMMARY OF INVENTION

### Technical Problem

However, there are cases where the aforementioned image generation AI encounters difficulties in reconstructing a normal image as a reconstruction image. In such a case, since the difference between the inspection image and the reconstruction image is large, there is a possibility that an inspection image is falsely determined (i.e., a false positive determination is made) to contain a defect a defect even though the inspection image is a normal image.

In one aspect, it is an object to reduce false positive determinations in an inspection system.

### Solution To Problem

One aspect of the present disclosure is a determination apparatus that includes:
a trained image reconstructing unit trained so as to reconstruct a first image from a first mask image in which a mask is overlaid onto an inspection region of the first image, the mask being colored according to types of material included in a corresponding region of an inspection target object and being configured to be overlaid onto the inspection region, the first image being an image determined not to contain a defect among captured images of the inspection target object; and
a determination unit configured to compare a second reconstruction image with a second image to determine whether or not the second image contains a defect, the second reconstruction image being reconstructed by inputting a second mask image into the trained image reconstructing unit, the second mask image being an image in which the mask is overlaid on, and corresponds to, an inspection region of the second image, the second image being a captured image of the inspection target object.

### Advantageous Effects of Invention

False positive determinations in the inspection system can be reduced.

### BRIEF DESCRIPTION OF DRAWINGS

FIG. 1A is a diagram for describing an example of a training processing method of a comparative example for image generation AI.

FIG. 1B is a diagram for describing an example of a determination processing method of a comparative example when determining whether or not there is a defect by using a trained image generation AI.

FIG. 2A is a first diagram illustrating an example of a false positive determination.

FIG. 2B is a second diagram illustrating an example of a false positive determination.

FIG. 3A is a diagram illustrating an example of a training processing method for an image generation AI in an inspection system according to a first embodiment.

FIG. 3B is a first drawing illustrating an example of a determination processing method for determining whether or not there is a defect by using a trained image generation AI in the inspection system according to the first embodiment.

FIG. 3C is a second drawing illustrating examples of the determination processing method for determining whether or not there is a defect by using the trained image generation AI in the inspection system according to the first embodiment.

FIG. 4 is a diagram illustrating an example of a system configuration of an inspection system in a training phase according to the first embodiment.

FIG. 5 is a diagram illustrating an example of a hardware configuration of a training apparatus.

FIG. 6 is a diagram illustrating a specific example of processing performed by a training dataset generation unit of the training apparatus.

FIG. 7 is a diagram illustrating a specific example of processing performed by the training unit of the training apparatus.

FIG. 8 illustrates an example of the system configuration of the inspection system in an inspection phase according to the first embodiment.

FIG. 9 illustrates an example of the hardware configuration of a determination apparatus.

FIG. 10 illustrates a specific example of the processing performed by an inference unit of the determination apparatus.

FIG. 11 is a flowchart illustrating the flow of the training processing performed by the training apparatus of the inspection system according to the first embodiment.

FIG. 12 is a flowchart illustrating the flow of determination processing performed by the determination apparatus of the inspection system according to the first embodiment.

### DESCRIPTION OF EMBODIMENTS

Each embodiment is described below with reference to the attached drawings. In the present specification and the drawings, components having substantially the same functional configuration are denoted by the same reference numerals and thus duplicate descriptions are omitted.

### First Embodiment

### <Description of Training Processing Method and Determination Processing Method of Comparative Example for Image Generation AI>

As is described further below, in an inspection system according to the first embodiment, a training processing method and a determination processing method different from a general training processing method and a general determination processing method are applied to the image generation AI in order to reduce false positive determinations.

Therefore, the general training processing method and the general determination processing method (referred to as a training processing method and a determination processing method of the comparative example) for the image generation AI is described below first. Thereafter, cases in which false positive determination occurs in the training processing method and the determination processing method of the comparative example is described, and then the training processing method and the determination processing method for the image generation AI in the inspection system according to the first embodiment that can reduce false positive determinations is described.

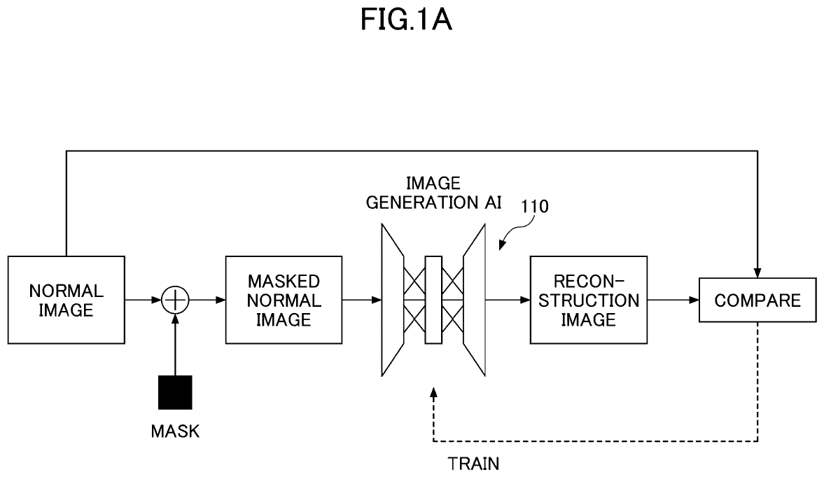

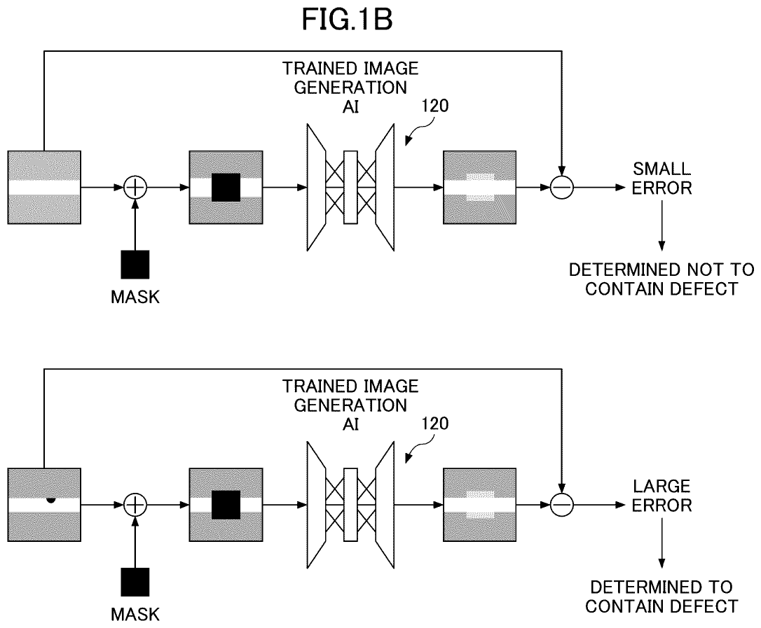

FIG. 1A is a diagram for describing an example of the training processing method of the comparative example for the image generation AI. As illustrated in FIG. 1A, in the case of the training processing method of the comparative example, training processing is performed for an image generation AI 110 in the following procedure.
An inspection image of an inspection target object determined to be a defect-free product (referred to as a normal image), among images captured in the inspection system, is acquired, and a masked normal image is generated by overlaying a mask on an inspection region.
By inputting the generated masked normal image into the image generation AI 110, the reconstruction image output from the image generation AI 110 is compared with the normal image to calculate an error.
The model parameters of the image generation AI 110 are updated such that the calculated error becomes smaller. This processing is performed on multiple normal images to perform training processing on the image generation AI 110, thereby generating the trained image generation AI.

Next, the determination processing method of the comparative example when determining whether or not the inspection image contains a defect by using the generated trained image generation AI is described.

FIG. 1B is a diagram for describing an example of the determination processing method of the comparative example when determining whether or not there is a defect by using the trained image generation AI. As illustrated in the upper part of FIG. 1B, in the case of the comparative example, the determination processing is performed by the following procedure using a trained image generation AI 120, and it is determined that there is no defect.
A masked inspection image is generated by acquiring an inspection image captured in the inspection system and overlaying a mask on an inspection region.
The generated masked inspection image is input into the trained image generation AI 120, and the trained image generation AI 120 outputs a reconstruction image.
The error between the reconstruction image output by the trained image generation AI 120 and the inspection image is calculated, and the result indicating that the error is small is acquired. Since the trained image generation AI 120 is trained so as to reconstruct the normal image for the input masked inspection image, the reconstruction image output by the trained image generation AI 120 closely resembles the normal image.
Therefore, if the calculated error is small, the inspection image can be regarded as an image that closely resembles the normal image. As a result, it can be determined that the inspection image does not contain a defect.

On the other hand, as illustrated in the lower part of FIG. 1B, in the case of the comparative example, the determination processing is performed by using the trained image generation AI 120 in the following procedure, and it is determined that there is a defect.
A masked inspection image is generated by acquiring an inspection image captured in the inspection system and overlaying a mask on the inspection region.
By inputting the generated masked inspection image is input into the trained image generation AI 120, the trained image generation AI 120 outputs a reconstruction image.
The error between the reconstruction image output by the trained image generation AI 120 and the inspection image is calculated, and the result indicating that that the error is large is acquired. As described above, since the trained image generation AI 120 is trained to reconstruct the normal image for the input masked inspection image, the reconstruction image output by the trained image generation AI 120 closely resembles the normal image.
Therefore, if the calculated error is large, the inspection image can be regarded as being far from the normal image. As a result, it can be determined that the inspection image contains a defect.

In FIG. 1B, for the sake of simplicity of description, it is assumed that a determination is made as to whether or not the inspection image contains a defect based on the size of the calculated error. However, the determination made as to whether or not the inspection image contains a defect is not limited to this. For example, it is possible to perform image processing by using the inspection image and the reconstruction image, and make a determination based on the result of the image processing. However, in this embodiment, for the sake of simplicity of description, the case in which a determination is made as to whether or not the inspection image contains a defect based on the size of the calculated error is described.

### <Description of False Positive Determination>

Next, a case where an inspection image that ought to be determined not to contain a defect by the trained image generation AI 120 is falsely determined (i.e., a false positive determination is made) to contain a defect is described.

### (1) Case 1

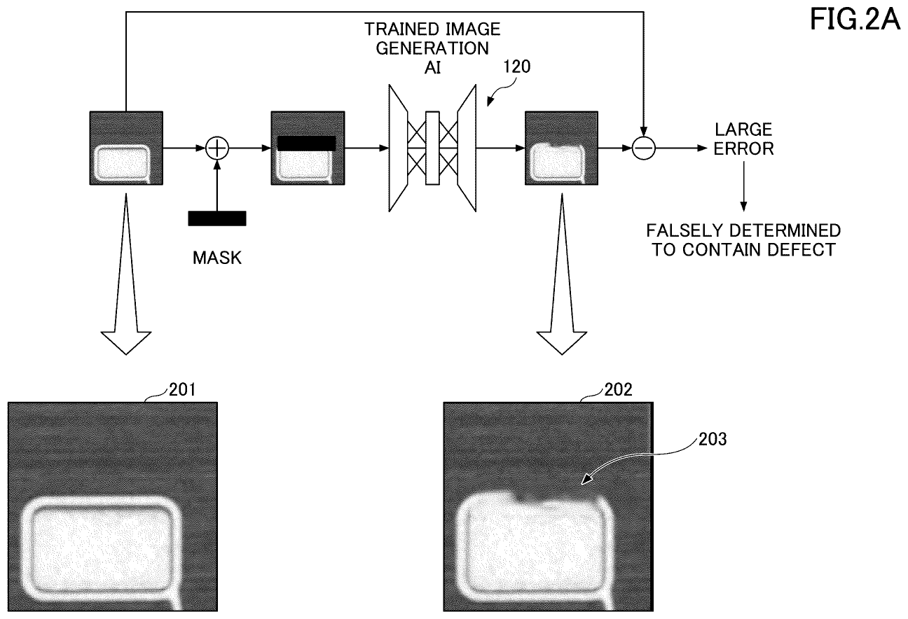

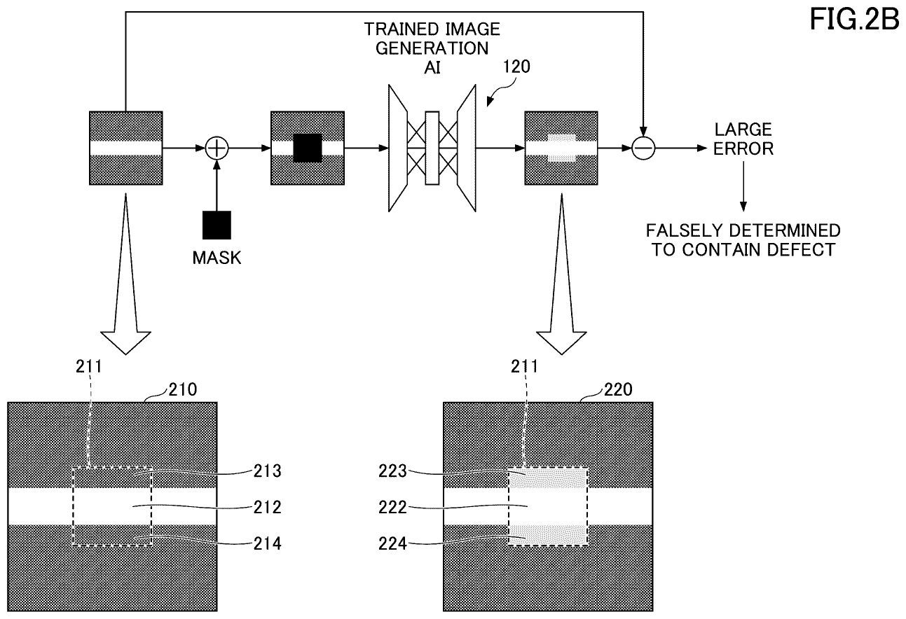

As an example of a false positive determination, there is a case in which it is difficult to reconstruct a normal image because the inspection target object is composed of several types of materials and the inspection region where the mask is overlaid overlaps with a boundary portion of the materials. This is described in detail using FIG. 2A. FIG. 2A is the first drawing illustrating an example of a false positive determination.

In FIG. 2A, an inspection image 201 is an example of an inspection image that is falsely determined to contain a defect by the trained image generation AI 120 even though it does not actually contain a defect. The inspection target object corresponding to the inspection image 201 has the following structure.
It is composed of two different types of material.
The boundary portion of the two types of material overlaps with the inspection region where the mask is overlaid.

In the case of the inspection image 201, when an inspection image with a mask is input into the trained image generation AI 120, the trained image generation AI 120 reconstructs a reconstruction image 202. As illustrated in FIG. 2A, in the case of the reconstruction image 202, the boundary portion of two types of material is not properly reconstructed (refer to reference numeral 203).

In such a case, since the error between reconstruction image and inspection image increases, a false positive determination is made that the inspection image contains a defect even though it does not actually contain a defect.

In contrast to this, in the inspection system according to the first embodiment, material information is added to the mask as color information in order to properly reconstruct the boundary portion of materials and reduce false positive determinations (details are described further below).

### (2) Case 2

As another example of a false positive determination, there is a case where it is difficult to reconstruct a normal image because the inspection target object is composed of multiple types of materials and the inspection region where the mask is overlain contains a material that makes it difficult to reconstruct a normal image. FIG. 2B is described in detail. FIG. 2B is a second drawing illustrating an example of false positive determination.

In FIG. 2B, an inspection image 210 is another example of an inspection image that has been falsely determined to contain a defect by the trained image generation AI 120, even though it does not actually contain a defect. The inspection target object corresponding to the inspection image 210 has the following configuration.
It is composed of two different types of materials.
Of the two types of materials, one material (white region of the inspection image 210) has less surface irregularities, whereas the other material (hatched region of the inspection image 210) has fine and irregular asperities on the surface.
Among the two types of materials, the material with a surface having fine and irregular asperities corresponds to a base layer of inspection target object, whereas the material with a surface having few asperities corresponds to the portion of inspection target object other than the base layer (for example, a circuit portion in the case where the inspection target object is a printed circuit board).

In the case of the inspection image 210, when a masked inspection image with an overlaid mask is input into the trained image generation AI 120, the trained image generation AI 120 reconstructs a reconstruction image 220. As illustrated in FIG. 2B, in the case of the reconstruction image 220, the image is reconstructed such that the white region 222 (region corresponding to material with a surface having few asperities) in a region 211 with an overlaid mask is the same as a white region 212 (region corresponding to material with a surface having few asperities) of the inspection image 210.

In contrast to this, in regions 223 and 224 (regions corresponding to material with a surface having fine and irregular asperities), images such as hatching regions 213 and 214 (regions corresponding to a material with a surface having fine and irregular asperities) of the inspection image 210 are not reconstructed. Specifically, in the regions 223 and 224 (regions corresponding to material with a surface having fine and irregular asperities), the surface having fine and irregular asperities is not reconstructed, and thus a flat image is reconstructed. In other words, in the case of the inspection image 210, the inspection region includes a base layer region where it is difficult to reconstruct the normal image.

In such a case, since the error between the reconstruction image 220 and the inspection image 210 is large, the inspection image 210 is falsely determined to contain a defect.

In contrast to this, in the inspection system according to the first embodiment, the base layer region is removed (details are described further below) when calculating the error between the reconstruction image 220 and the inspection image 210. This approach suppresses the influence of the base layer region where it is difficult to reconstruct the normal image, and thus false positive determinations can be reduced.

### <Training Processing Method for Image Generation AI in Inspection System According to First Embodiment>

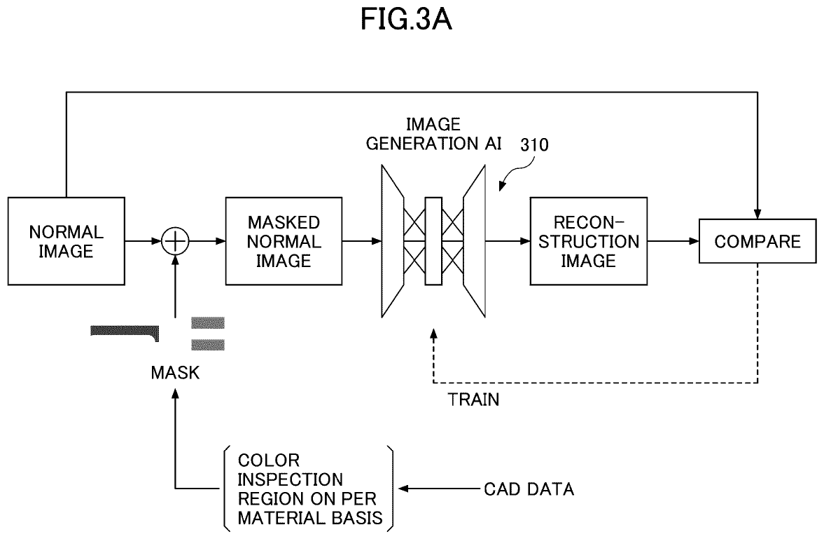

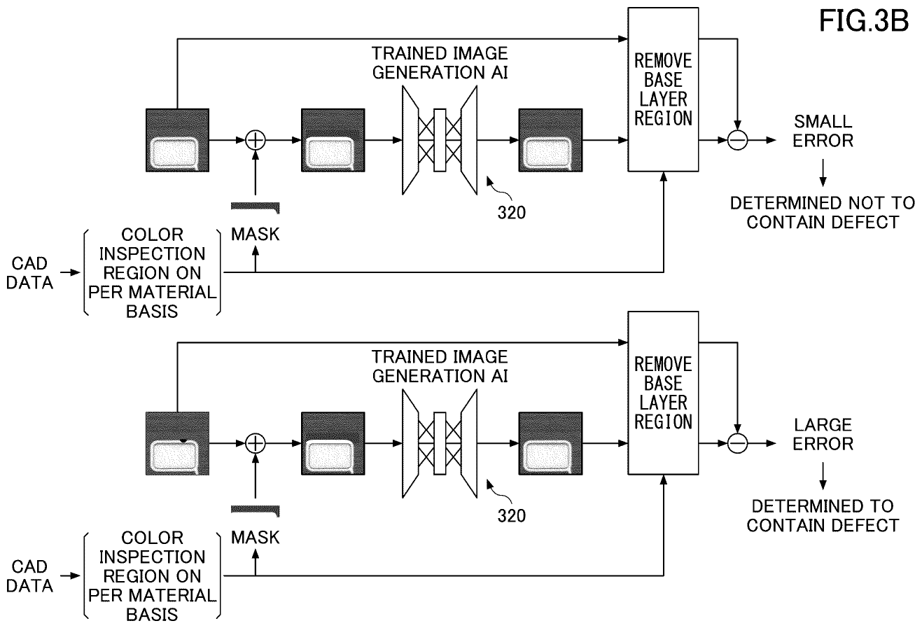

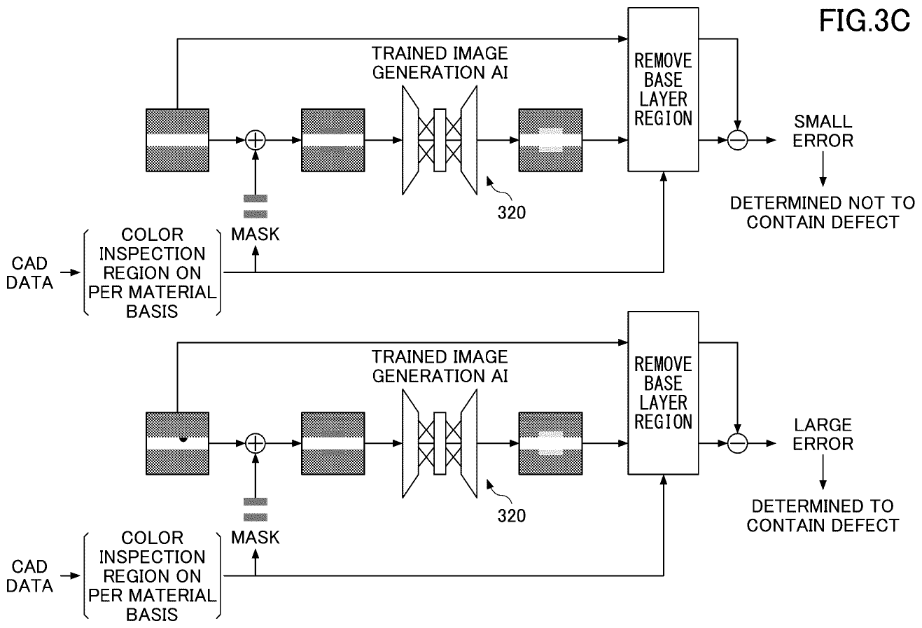

A training processing method for image generation AI in the inspection system according to the first embodiment is described. FIG. 3A is a diagram illustrating an example of a training processing method for image generation AI in the inspection system according to the first embodiment.

The difference from the training processing method of the comparative example illustrated in FIG. 1A is that in FIG. 3A, material information obtained based on computer-aided design (CAD) data is added as color information to the mask used to generate the masked normal image.

Specifically, in FIG. 3A, the mask is generated by, for example, the following procedure.
a) A normal image is acquired among inspection images captured in the inspection system, and CAD data of the inspection target object corresponding to the acquired normal image is acquired.
b) CAD data of the inspection region is extracted from the acquired CAD data, and the types of material included in the extracted CAD data is identified.
c) A mask is generated by adding different colors for each identified types of material.

Thus, in the inspection system according to the first embodiment, a mask in which material information obtained based on CAD data is added as color information is used. Thus, even in a case where it is difficult to reconstruct a normal image because the inspection region onto which the mask is overlaid overlaps with the boundary portion of materials, the boundary portion of the materials can be properly reconstructed, and false positive determinations can be reduced.

The above procedure for generating a mask is an example, and the mask may be generated by other procedures. For example, the mask may be generated in the order in which b) and c) are reversed. Specifically, the mask may be generated by identifying the types of materials included in the acquired CAD data, adding different colors for each of the identified types of materials, and then extracting the CAD data of the inspection region from the CAD data to which the color is added.

Next, a determination processing method for determining whether or not there is a defect using trained image generation AI in the inspection system according to the first embodiment is described.

FIG. 3B is a first drawing illustrating an example of a determination processing method for determining whether or not there is a defect by using the trained image generation AI in the inspection system according to the first embodiment. The differences from FIG. 2A are as follows. In the case of FIG. 3B:
material information obtained based on CAD data is added as color information to the mask to be used to generate the masked inspection image, and
when comparing the inspection image with the reconstruction image and calculating the error, the base layer region is removed from both the inspection image and the reconstruction image and then the error is calculated.

As illustrated in FIG. 3B, even when the boundary portion of two types of material overlaps with the inspection region onto which the mask is overlaid, the boundary portion can be properly reconstructed by adding material information obtained based on CAD data to the mask overlaid on the inspection region as color information. As a result, when the inspection image does not contain a defect (in the case of the upper part of FIG. 3B), it can be appropriately determined that there is no defect. Conversely, when the inspection image contains a defect (in the case of the lower part of FIG. 3B), it can be appropriately determined that there is a defect.

In the case of the inspection image illustrated in FIG. 3B, since the material of the base layer region is not material with a surface having fine and irregular asperities, the effect of calculating the error after removing the base layer region is not so great. Therefore, a detailed description of the process of calculating the error after removing the base layer region is omitted here.

FIG. 3C is a second drawing illustrating an example of a determination processing method for determining whether or not there is a defect using trained image generation AI in the inspection system according to the first embodiment. The differences from FIG. 2B are as follows.

In the case of FIG. 3C:
material information obtained based on CAD data is added as color information to the mask used to generate the masked inspection image, and
when comparing the inspection image with the reconstruction image and calculating the error, the base layer region is removed from both the inspection image and the reconstruction image and then the error is calculated.

In the case of the inspection image illustrated in FIG. 3C, the effect of adding material information obtained based on CAD data as color information is not so great because the mask overlaid on the boundary portion of two types of material is small. Therefore, the detailed description of the process of adding material information obtained based on CAD data as color information is omitted here, and the details of the processing of calculating the error after removing the base layer region are described.

As illustrated in FIG. 3C, the processing of calculating the error after removing the base layer region is performed as follows.
In the inspection image, the base layer region that is the inspection region onto which the mask is to be overlaid and is identified as the base layer based on CAD data is removed.
In the reconstruction image, the base layer region, that is the inspection region onto which the mask is overlaid and is identified as the base layer based on CAD data is removed.
The inspection image from which the base layer region is removed is compared with the reconstruction image from which the base layer region is removed, and the error is calculated.

Thus, even if the inspection region onto which the mask is overlaid contains the base layer region where it is difficult to be reconstructed as a normal image, the influence of the base layer region can be suppressed. As a result, when the inspection image does not contain the defect (in the case of the upper part of FIG. 3C), it can be properly determined that there is no defect. Also, when the inspection image contains the defect (in the case of the lower part of FIG. 3C), it can be appropriately determined that there is a defect.

Thus, in the inspection system according to the first embodiment, false positive determinations can be reduced even in cases where it is difficult to reconstruct the normal image, that is:
even in cases where it is difficult to reconstruct the normal image because the inspection region onto which the mask is overlaid overlaps with the boundary portion of materials, or
even in cases where it is difficult to reconstruct the normal image because the inspection region includes a base layer region where it is difficult to reconstruct the normal image.

### <System Configuration of Inspection System (Training Phase)>

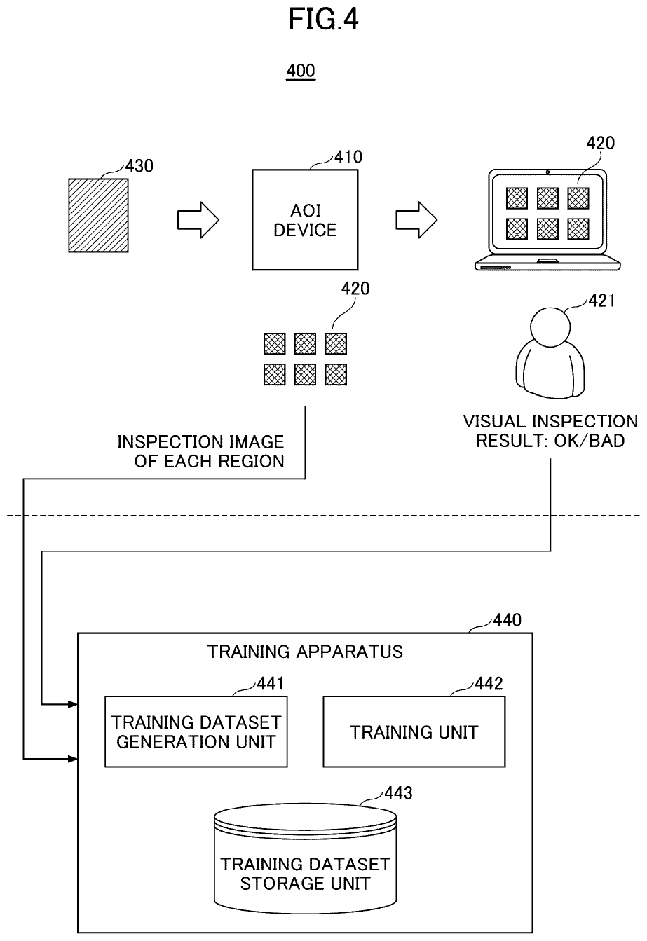

Next, a system configuration of the inspection system in the training phase according to the first embodiment to which the image generation AI is applied is described. FIG. 4 is a diagram illustrating an example of the system configuration of the inspection system in the training phase according to the first embodiment.

As illustrated in FIG. 4, an inspection system 400 in the training phase includes an automated optical inspection (AOI) device 410 and a training apparatus 440.

The AOI device 410 performs automatic visual inspection of the printed circuit board 430. The AOI device 410 detects a defect candidate by scanning the printed circuit board 430 with a camera and inspecting various inspection items. The inspection items checked by the AOI device 410 include, for example, circuit width, circuit spacing, missing pads/no pads, circuit shorts, and the like.

An inspection image 420 of each region containing a defect candidate detected by the AOI device 410 is transmitted to the training apparatus 440 and to the inspection line. In the inspection line, a human inspector 421 or the like performs visual inspection of the inspection image 420 of each region containing a defect candidate. It is assumed that the AOI device 410 is set so that the inspection image of each region containing a defect candidate is detected with an intentionally high sensitivity so that defective products are not determined to be defect-free products.

The human inspector 421 or the like performs visual inspection to determine whether or not the inspection image 420 of each region includes a defect, and ultimately determines whether the printed circuit board 430 is a defect-free product or a defective product. Specifically, if there is no defect in any of the inspection images 420 of the regions containing defect candidates, the printed circuit board 430 is determined to be a defect-free product. If any defect is included in any of the inspection images 420 of the regions containing the defect candidates, the printed circuit board 430 is determined to be a defective product.

The human inspector 421 or the like notifies the training apparatus 440 of the result of the visual inspection (results of determining whether defect is included in inspection image 420 of each region). In the example illustrated in FIG. 1, “visual inspection result: OK” indicates that the image of the region containing the defect candidate does not contain any defects, whereas “visual inspection result: BAD” indicates that an image of the region containing the defect candidate contains a defect.

A training program is installed in the training apparatus 440, and the training apparatus 440 functions as a training dataset generation unit 441 and a training unit 442 by executing the program.

The training dataset generation unit 441 extracts the inspection image (normal image) that is determined not to contain a defect as the result of the visual inspection by the human inspector 421 or the like among the inspection images 420 of each region containing the defect candidate transmitted from the AOI device 410. The training dataset generation unit 441 reads the CAD data of the printed circuit board 430, and extracts the region corresponding to the inspection image (normal image) that is determined not to contain a defect from the read CAD data. The training dataset generation unit 441 generates a mask in which the inspection region is colored according to the types of material obtained based on the CAD data of the extracted region.

The training dataset generation unit 441 also associates:
the inspection image (normal image) of each extracted region,
the result of visual inspection,
region corresponding to the inspection image of each region extracted from CAD data,
a generated mask and
   with one another and stores them as a training dataset (i.e., a dataset for training) in a training dataset storage unit 443.

The training unit 442 reads the inspection image (normal image) of each region included in the training dataset stored in the training dataset storage unit 443. The training unit 442 generates a masked normal image by overlaying the generated mask onto the inspection region of the extracted inspection image (normal image) of each region. The training unit 442 also performs training processing on the model so that the inspection image (normal image) of each region is reconstructed from the generated masked normal image.

The model for which training processing is performed by the training unit 442 uses the image generation AI described above. Hereinafter, the model is referred to as the “image reconstructing unit”.

### <Hardware Configuration of Training Apparatus>

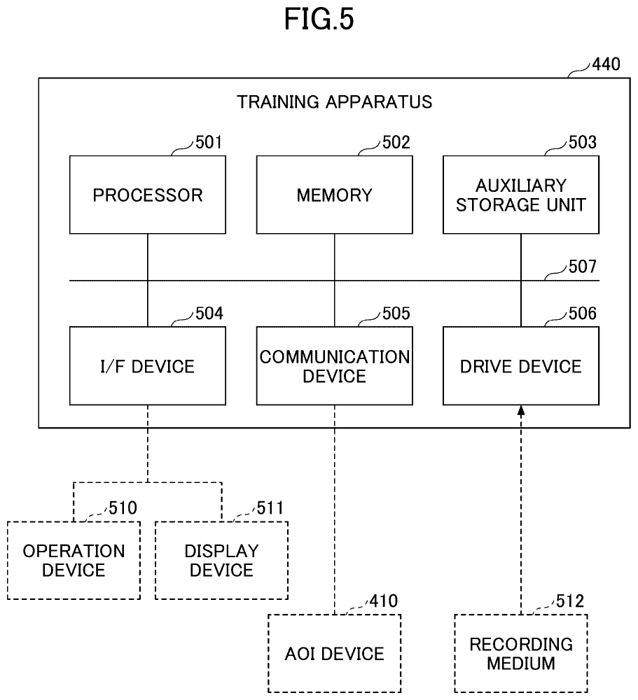

Next, the hardware configuration of the training apparatus 440 is described. FIG. 5 illustrates an example of the hardware configuration of the training apparatus. As illustrated in FIG. 5, the training apparatus 440 has a processor 501, a memory 502, an auxiliary storage device 503, an interface (I/F) device 504, a communication device 505, and a drive device 506. Each hardware component of the training apparatus 440 is interconnected via a bus 507.

The processor 501 includes various computing devices such as a central processing unit (CPU) and a graphics processing unit (GPU). The processor 501 reads various programs (for example, training program) into the memory 502 and executes them.

The memory 502 has main storage devices such as read-only memory (ROM) and random access memory (RAM). The processor 501 and the memory 502 form what is known as a computer. When the processor 501 executes various programs read into the memory 502, the computer achieves, for example, the functions (training dataset generation unit 441 and training unit 442) described above.

The auxiliary storage device 503 stores various programs and various data used when the various programs are executed by the processor 501. For example, the training dataset storage unit 443 is implemented in the auxiliary storage device 503.

The I/F device 504 is a connection device that connects an operation device 510 and a display device 511, which are examples of external devices, to the training apparatus 440. The I/F device 504 receives operations (for example, the operation of inputting the result of visual inspection by the human inspector 421 or the like, or the operation of inputting the instructions of training processing given by a person, i.e. a manager (not illustrated) who manages the training apparatus 440) performed with respect to the training apparatus 440 via the operation device 510. The I/F device 504 outputs the results of training processing performed by the training apparatus 440 and displays them to the manager of the training apparatus 440 via the display device 511.

The communication device 505 is a communication device for communicating with other devices (in this embodiment, the AOI device 410).

The drive device 506 is a device in which the recording medium 512 is set. The recording medium 512 here includes a medium for recording information optically, electrically, or magnetically, such as a CD-ROM, a flexible disk, or a magneto-optical disk. The recording medium 512 may also include a semiconductor memory for recording information electrically, such as a ROM, flash memory, or the like.

The various programs installed in the auxiliary storage device 503 are installed, for example, when the distributed recording medium 512 is set in the drive device 506 and the various programs recorded in the recording medium 512 are read by the drive device 506. Alternatively, the various programs installed in the auxiliary storage device 503 may be installed by downloading them from the network via the communication device 505.

### <Details of Each Unit of Training Apparatus>

Next, details of each unit (training dataset generation unit 441 and training unit 442) of the training apparatus 440 is described.

### (1) Specific Example of Processing Performed by Training Dataset Generation Unit

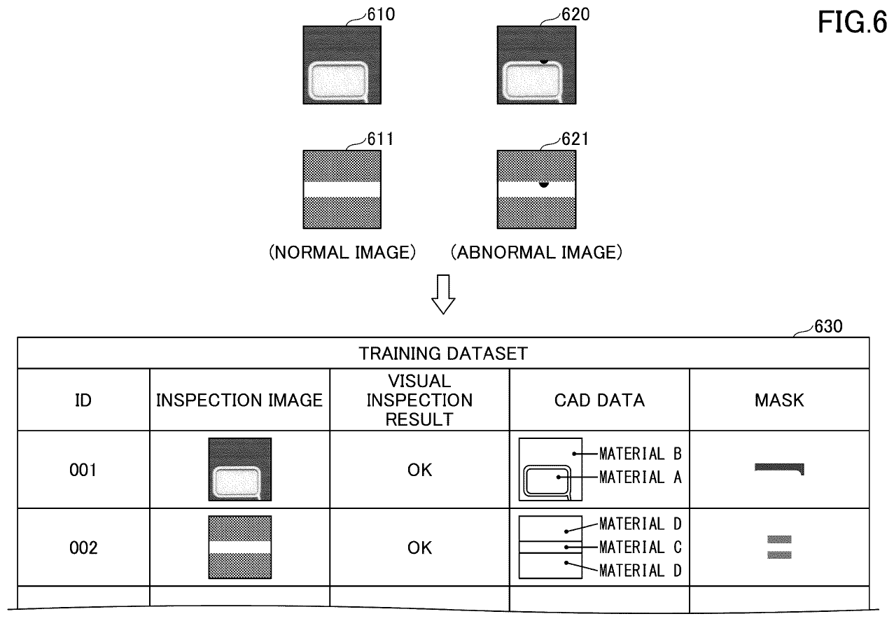

FIG. 6 illustrates a specific example of processing performed by the training dataset generation unit of the training apparatus. As illustrated in FIG. 6, when inspection images 610, 611, 620, and 621 of each region containing a defect candidate are transmitted from the AOI device 410, for example, the training dataset generation unit 441 extracts any normal images given the “visual inspection result: OK”.

The example of FIG. 6 illustrates that the inspection images 620 and 621 among the inspection images 610, 611, 620, and 621 of each region are abnormal images given the “visual inspection result: BAD”. Therefore, the training dataset generation unit 441 extracts the inspection images 610 and 611 (An example of a first image. Normal images given the “visual inspection result: OK”) of each region to generate a training dataset 630.

As illustrated in FIG. 6, the training dataset 630 has “ID”, “inspection image”, “visual inspection result”, “CAD data”, and “mask” as items of information.

An identifier identifying the inspection image (normal image) is stored as the “ID”. The inspection image (normal image) of each region is stored as “inspection image”. The visual inspection result of the inspection image (normal image) of each region is stored as “visual inspection result”. Since only the normal images given the “visual inspection result: OK” are stored in the training dataset 630, only “OK” is stored as the “visual inspection result”.

CAD data of the region corresponding to the inspection image (normal image) stored as the “inspection image” extracted from the CAD data of the corresponding inspection target object (for example, printed circuit board 430) is stored as “CAD data”.

The mask generated by extracting the inspection region onto which the mask is overlaid from the CAD data stored as “CAD data”, and applying the color corresponding to the material type is stored as the “mask”. Alternatively, the mask generated by applying the color corresponding to the material type, and extracting the inspection region onto which the mask is overlaid from the CAD data stored in the “CAD data” is stored as the “mask”.

### (2) Specific Example of Processing Performed by Training Unit

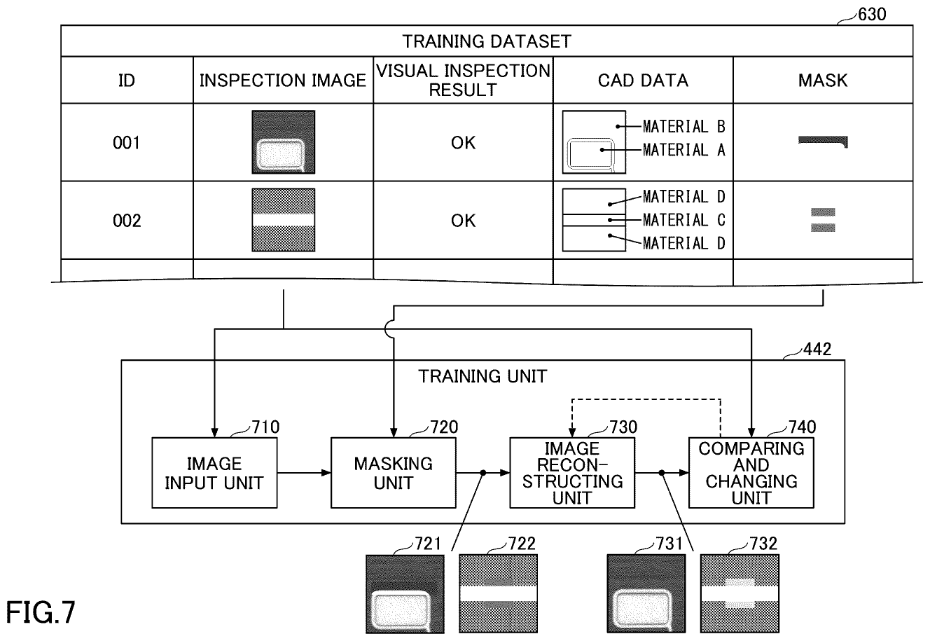

FIG. 7 illustrates a specific example of processing performed by the training unit of the training apparatus. As illustrated in FIG. 7, the training unit 442 includes an image input unit 710, a masking unit 720, an image reconstructing unit 730, and a comparing and changing unit 740.

The image input unit 710 reads the inspection images (for example, inspection images 610 and 611 (normal images)) of each region stored as the “inspection image” of the training dataset 630 stored in the training dataset storage unit 443, and inputs them into the masking unit 720.

The masking unit 720 reads the mask stored as the “mask” of the training dataset 630 stored in the training dataset storage unit 443. Further, the masking unit 720 generates a masked normal image (Example of a first mask image. For example, masked normal images 721 and 722) by overlaying the read mask onto the inspection region of the inspection image (normal image) input by the image input unit 710. Further, the masking unit 720 inputs the generated masked normal images 721 and 722 into the image reconstructing unit 730.

The image reconstructing unit 730 reconstructs the reconstruction image (Example of a first reconstruction image. For example, reconstruction images 731 and 732) based on the masked normal images 721 and 722, and outputs the reconstructed reconstruction images 731 and 732 to the comparing and changing unit 740.

The comparing and changing unit 740 compares the reconstruction images 731 and 732 reconstructed by the image reconstructing unit 730 with the inspection image (Normal image. For example, inspection images 610 and 611) read out by the image input unit 710, and updates the model parameters of the image reconstructing unit 730 so that they match.

Thus, the image reconstructing unit 730 performs training processing such that the inspection images 610 and 611 (normal images) are reconstructed from the masked normal images 721 and 722 generated by the masking unit 720. The trained image reconstructing unit in which training processing is performed so that the inspection images (normal images) are reconstructed is used in an inspection phase described below.

### <System Configuration of Inspection System (Inspection Phase)>

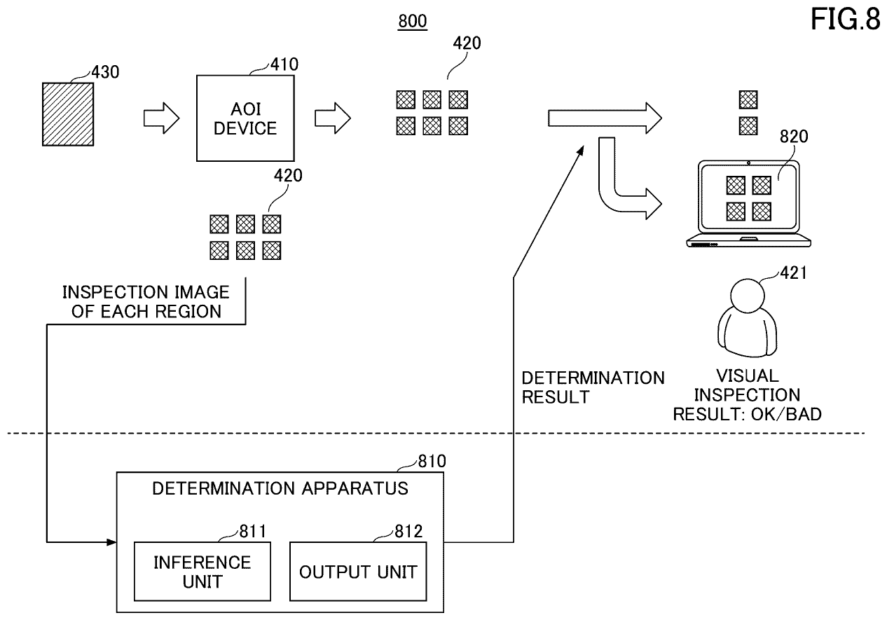

Next, the system configuration of the inspection system according to the first embodiment in an inspection phase is described. FIG. 8 illustrates an example of the system configuration of the inspection system in the inspection phase according to the first embodiment.

As illustrated in FIG. 8, an inspection system 800 in the inspection phase includes the AOI device 410 and a determination apparatus 810.

Among these, the AOI device 410 is the same as the AOI device 410 of the inspection system 400 in the training phase, so description is omitted here.

A determination program is installed in the determination apparatus 810, and when this program is executed, the determination apparatus 810 functions as an inference unit 811 and an output unit 812.

The inference unit 811 includes a trained image reconstructing unit generated in the training phase. The inference unit 811 acquires an inspection image 420 of each region transmitted from the AOI device 410 by performing automatic visual inspection on the inspection target object (printed circuit board 430, for example). Further, the inference unit 811 generates a masked inspection image by overlaying a mask onto the inspection region of the acquired inspection image 420 of each region. Further, the inference unit 811 reconstructs the reconstruction image by inputting the generated masked inspection image into the trained image reconstructing unit. Further, the inference unit 811 determines whether or not the inspection image 420 of each region contains a defect by comparing the reconstruction image with the inspection image 420. Further, the inference unit 811 notifies the output unit 812 of the determination result.

The output unit 812 outputs the determination result reported by the inference unit 811 to the inspection line. In the inspection line, the human inspector 421 performs visual inspection of the inspection image of each region containing the defect candidate. However, in the inspection phase, a determination result output by the output unit 812 is referred to, and the inspection images determined not to contain a defect by the determination apparatus 810 among the inspection images 420 of each region containing the defect candidate are excluded. Then, in the inspection line, the inspection images 820 determined to contain a defect by the determination apparatus 810 among the inspection images 420 of each region containing the defect candidate are designated to be visually inspected. In other words, the output unit 812 outputs the inspection images 820 to perform visual inspection of the inspection images 820 determined to contain a defect.

As described above, when automatic visual inspection is performed on the inspection target object in the AOI device 410 and the inspection images 420 of each region containing a defect candidate are detected, the inspection line designates the inspection images determined to contain the defect by the determination apparatus 810 to be visually inspected. As a result, according to the inspection system 800, the number of inspection images designated for visual inspection can be reduced, and the workload of the visual inspection by the human inspector 421 can be reduced.

### <Hardware Configuration of Determination Apparatus>

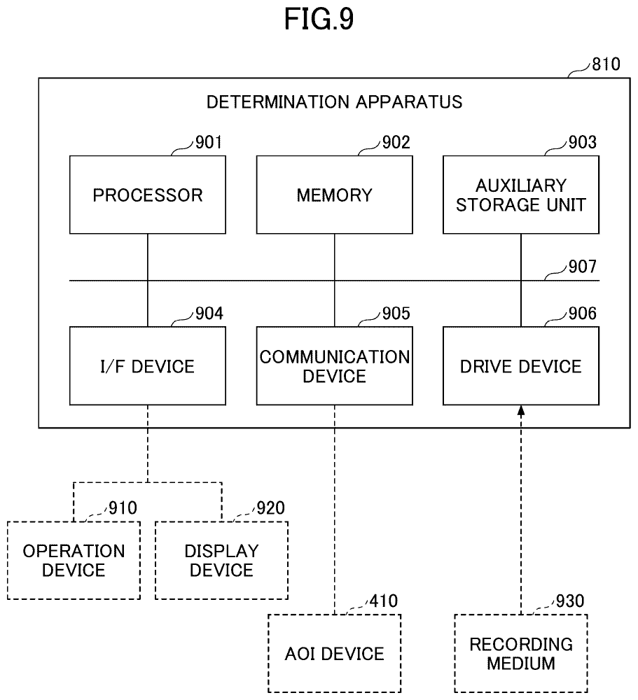

Next, the hardware configuration of the determination apparatus 810 is described. FIG. 9 is a diagram illustrating an example of the hardware configuration of the determination apparatus. As illustrated in FIG. 9, the hardware configuration of the determination apparatus 810 is almost the same as the hardware configuration of the training apparatus 440. Therefore, the following description will focus on the differences from the hardware configuration of the training apparatus 440.

As illustrated in FIG. 9, a processor 901 reads various programs (determination program, for example) into a memory 902 and executes them. By the processor 901 executing the various programs read into the memory 902, the computer formed by the processor 901 and the memory 902 achieves, for example, the aforementioned functions (inference unit 811 and output unit 812).

### <Details of Each Unit of Determination Apparatus>

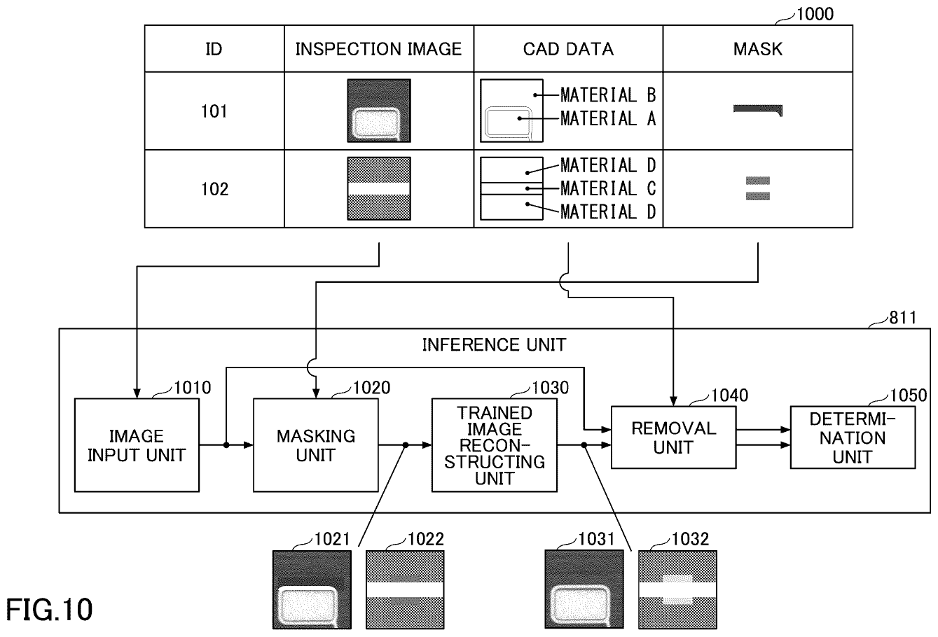

Next, details of each unit (here, inference unit 811) of the determination apparatus 810 is described. FIG. 10 is a diagram illustrating a specific example of processing performed by the inference unit of the determination apparatus. As illustrated in FIG. 10, the inference unit 811 includes an image input unit 1010, a masking unit 1020, a trained image reconstructing unit 1030, a removal unit 1040, and a determination unit 1050.

The image input unit 1010 acquires an inspection image (An example of a second image) of each region from the input image dataset 1000 containing an inspection image of each region transmitted from the AOI device 410, and inputs the acquired inspection image into the masking unit 1020. When the image input unit 1010 is to acquire an inspection image of each region, it is assumed that the input image dataset 1000 has been generated in advance.

As illustrated in FIG. 10, the input image dataset 1000 has “ID”, “inspection image”, “CAD data”, and “mask” as items of information.

An identifier identifying the inspection image of each region is stored as “ID”. An inspection image of each region is stored as “inspection image”. CAD data of the region corresponding to the inspection image stored as “inspection image” extracted from the CAD data of the corresponding inspection target object (for example, printed circuit board 430) is stored as “CAD data”. The mask generated mask by extracting the inspection region onto which the mask is overlaid from the CAD data stored as “CAD data”, and applying the color corresponding to the material type is stored as the “mask”. Alternatively, the mask generated by applying the color corresponding to the material type to the CAD data stored in the “CAD data”, and extracting the inspection region onto which the mask is overlaid is stored as the “mask”.

The masking unit 1020 reads the mask stored as the “mask” of the input image dataset 1000. The masking unit 1020 also overlays the read mask onto the inspection region of the inspection image input by the image input unit 1010 to generate a masked inspection image (An example of a second mask image. For example, masked inspection images 1021 and 1022). Further, the masking unit 1020 inputs the generated masked inspection images 1021 and 1022 into the trained image reconstructing unit 1030.

The trained image reconstructing unit 1030 is a trained model generated by performing training processing on the image reconstructing unit 730 in the training phase. The trained image reconstructing unit 1030 reconstructs a reconstruction image (An example of a second reconstruction image. For example, reconstruction images 1031 and 1032) based on the masked inspection image.

The removal unit 1040 reads the material type from the “CAD data” of the input image dataset 1000, and identifies the material corresponding to the base layer (In the example of FIG. 10, material B and material D). The removal unit 1040 also removes the base layer region which is the identified material region from the inspection image read by the image input unit 1010, and notifies the determination unit 1050 of the post-removal inspection image. The removal unit 1040 also removes the base layer region which is the identified material region from the reconstruction images 1031 and 1032 reconstructed by the trained image reconstructing unit 1030, and notifies the determination unit 1050 of the post-removal reconstruction images.

The determination unit 1050 compares the post-removal inspection image with the post-removal reconstruction image reported by the removal unit 1040, and determines whether or not the inspection image contains a defect.

Specifically, the determination unit 1050 calculates the mean square error (MSE) of pixel values of corresponding pixels between the post-removal inspection image and the post-removal reconstruction image. Subsequently, the determination unit 1050 determines whether the calculated MSE is less than or equal to a predetermined threshold (Th). If it is determined that the calculated MSE is less than or equal to the predetermined threshold, it is determined that the inspection image read by the image input unit 1010 does not contain a defect. On the other hand, if it is determined that the calculated MSE exceeds a predetermined threshold, it is determined that the inspection image read by the image input unit 1010 contains a defect.

In this way, the inference unit 811 reconstructs the reconstruction image from the masked inspection image onto which the mask with color information added according to the material information is overlaid. Thus, according to the inference unit 811, even in the case (the inspection image having the ID=101) where it is difficult to reconstruct the normal image because the inspection region onto which the mask is overlaid overlaps with the boundary portion of materials, the boundary portion of the materials can be properly reconstructed. As a result, according to the inference unit 811, false positive determinations can be reduced.

In addition, the inference unit 811 compares the reconstruction image with the inspection image after removing the base layer region to determine whether defects are included. Thus, according to the inference unit 811, even in the case (the inspection image having the ID=102) where it is difficult to reconstruct the normal image because the inspection region onto which the mask is overlaid includes the base layer region on which it is difficult to reconstruct the normal image, the influence of the base layer region can be suppressed. As a result, the inference unit 811 enables false positive determinations to be reduced.

### <Flow of Training Processing>

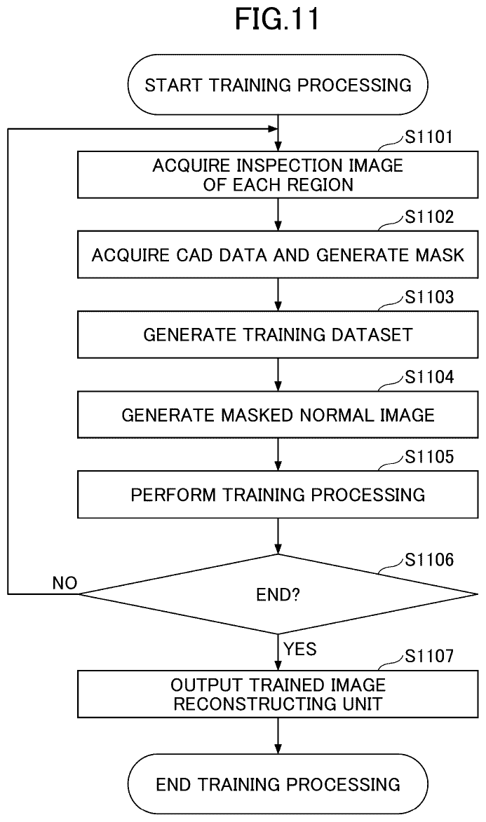

Next, a flow of training processing performed by the training apparatus 440 of the inspection system 400 is described. FIG. 11 is a flowchart illustrating the flow of training processing performed by the training apparatus of the inspection system according to the first embodiment.

In step S1101, the training dataset generation unit 441 of the training apparatus 440 acquires, from the AOI device 410, an inspection image of each region containing a defect candidate.

In step S1102, the training dataset generation unit 441 of the training apparatus 440 extracts a normal image given the “visual inspection result: OK” among the acquired inspection images of each region. In addition, the training dataset generation unit 441 of the training apparatus 440 acquires CAD data, extracts a region corresponding to the normal image given the “visual inspection result: OK”, and generates a mask.

In step S1103, the training dataset generation unit 441 of the training apparatus 440 generates a training dataset.

In step S1104, the training unit 442 of the training apparatus 440 generates a masked normal image by overlaying the mask included in the training dataset onto the inspection region of the inspection image (normal image) of each region included in the training dataset.

In step S1105, the training unit 442 of the training apparatus 440 performs training processing on the image reconstructing unit 730 so that the inspection image (normal image) is reconstructed from the generated masked normal image.

In step S1106, the training unit 442 of the training apparatus 440 determines whether to end the training processing. If it is determined in step S1106 that the training processing is to be continued (if NO in step S1106), the process returns to step S1101.

Conversely, if it is determined in step S1106 that the training processing is to be ended (if YES in step S1106), the process proceeds to step S1107.

In step S1107, the training unit 442 of the training apparatus 440 outputs the trained image reconstructing unit 1030 and ends the training processing.

### <Flow of Determination Processing>

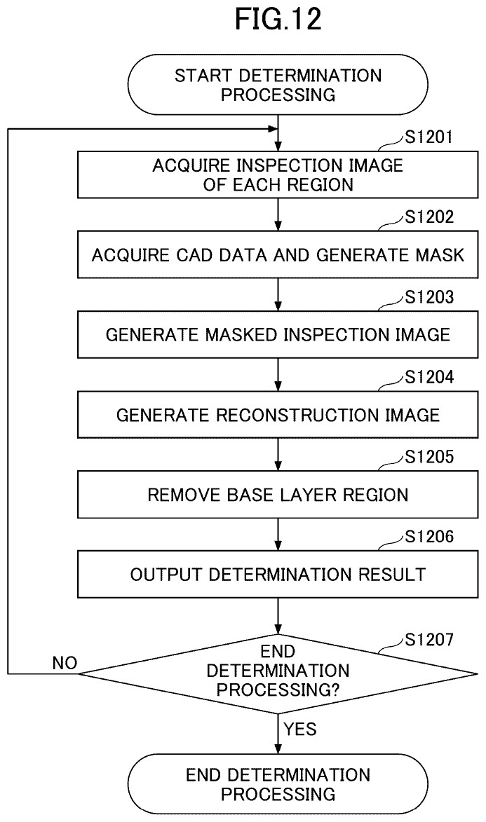

Next, the flow of determination processing performed by the determination apparatus 810 of the inspection system 800 is described. FIG. 12 is a flowchart illustrating the flow of determination processing performed by the determination apparatus of the inspection system according to the first embodiment.

In step S1201, the inference unit 811 of the determination apparatus 810 acquires an inspection image of each region containing a defect candidate from the AOI device 410.

In step S1202, the inference unit 811 of the determination apparatus 810 extracts a region of CAD data corresponding to the acquired inspection image of each region, and generates a mask.

In step S1203, the inference unit 811 of the determination apparatus 810 generates a masked inspection image by overlaying the generated mask onto the inspection region of the acquired inspection image of each region.

In step S1204, the inference unit 811 of the determination apparatus 810 reconstructs the reconstruction image by inputting generated masked inspection image into the trained image reconstructing unit 1030.

In step S1205, the inference unit 811 of the determination apparatus 810 generates a post-removal inspection image in which the base layer region is removed from the inspection image acquired in step S1201. In addition, the inference unit 811 of the determination apparatus 810 generates a post-removal reconstruction image in which the base layer region is removed from the reconstruction image reconstructed in step S1204.

In step S1206, the inference unit 811 of the determination apparatus 810 compares the post-removal inspection image with the post-removal reconstruction image to determine whether or not there is a defect in the inspection image acquired in step S1201. In addition, the inference unit 811 of the determination apparatus 810 outputs a determination result.

In step S1207, the inference unit 811 of the determination apparatus 810 determines whether or not to end the determination processing. In step S1207, if it is determined that the determination processing is to be continued (if NO in step S1207), the process returns to step S1201.

Conversely, in step S1207, if it is determined that the determination processing is to be ended (if YES in step S1207), the determination processing is ended.

### <Summary>

As is clear from the above description, the inspection system 400 according to the first embodiment generates a training dataset including:
a normal image that is determined to contain no defect among the inspection images acquired by capturing an images of the inspection target object; and a mask that is overlaid onto the inspection region of the normal image and is colored according to the types of material included in the corresponding region of the inspection target object.
A trained image reconstructing unit is generated by performing training such that the normal image included in the training dataset is reconstructed from the masked normal image created by overlaying a mask onto the inspection region of the normal image included in the training dataset.

In addition, the inspection system 800 according to the first embodiment
generates a masked inspection image by overlaying a mask colored according to the types of material included in the corresponding region of the inspection target object onto the inspection region of the inspection image acquired by capturing an image of the inspection target object.
The masked inspection image is input into the trained image reconstructing unit to reconstruct the reconstruction image.
By comparing the post-removal inspection image in which the base layer region is removed from the inspection image in which the inspection target object is image captured with the post-removal reconstruction image in which the base layer region is removed from the reconstructed reconstruction image, it is determined whether or not there is a defect in the inspection image in which the inspection target object is image captured.

Thus, according to the first embodiment, false positive determination in the inspection system can be reduced even in the case where it is difficult to reconstruct the normal image.

### Second Embodiment

In the first embodiment, the details of the color to be applied when the mask is generated are not described, but the color to be applied when the mask is generated may be different for each type of material, and any color may be applied. For example, in the first embodiment, the image taken by the AOI device 410 is a monochrome image, and in the first embodiment, a color that closely resembles the color of the image taken by the AOI device 410 (white, black, or gray) is applied to the mask. However, the color to be applied when generating the mask need not closely resemble the color of the image captured by the AOI device 410, and any color can be applied.

Further, in the first embodiment, by using the mask with the color corresponding to the types of material, the boundary portion of the materials can be properly reconstructed. However, instead of applying the color corresponding to the types of material, the mask may be, for example, a mask with a boundary line applied to the boundary portion of the materials. However, since the mask with the color corresponding to the types of material has more information than the mask with a boundary line applied to the boundary portion of the materials, the boundary portion of the materials can be more properly reconstructed.

Further, in the first embodiment, details of the extraction method when extracting CAD data of the area corresponding to the inspection image transmitted from the AOI device 410 are not described. However, when extracting CAD data of the corresponding area, processing such as position correction and size correction may be performed on the CAD data according to the inspection image, for example. This is because the position and size of the inspection image transmitted from the AOI device 410 may be different from the CAD data depending on the image capturing conditions in the AOI device 410.

In the first embodiment, the position of the inspection region where the mask is overlaid is not described, but it is assumed that the AOI device 410 adjusts the inspection region so that it is in the center of the inspection image. In the first embodiment, the size of the mask to be overlaid is not described, but it is assumed that the size of the mask to be overlaid is adjusted according to the size of the inspection region of the inspection image transmitted from the AOI device 410. However, no restriction is imposed regarding the position of the inspection region where the mask is overlaid and its size, and masks of any position and size can be overlaid.

In the first embodiment, the details of processing for determining whether or not the inspection image contains a defect by performing image processing using the inspection image and reconstruction image are not described, but such processes include, for example, the following processing.
The absolute value of the difference between the inspection image and reconstruction image for each pixel is calculated, and a difference image is generated.
A region where the absolute value of the difference is greater than or equal to a threshold value is extracted by performing binarization processing on the difference image.
Contour extraction processing is performed on the difference image after binarization processing, and the contour of the region where the absolute value of the difference is greater than or equal to a threshold value is extracted.
If the shape and size of the extracted contour satisfy the pre-determined conditions, it is determined that there is a defect. If the shape and size of the extracted contour do not satisfy the pre-determined conditions, it is determined that there is no defect.

Thus, by determining whether or not an inspection image contains a defect based on the result of image processing, the determination accuracy can be improved compared with the case of making a determination based on the magnitude of the error.

The present invention is not limited to the configurations described in connection with the embodiments that have been described heretofore, or to the combinations of these configurations with other elements. Various variations and modifications may be made without departing from the scope of the present invention, and may be adopted according to applications.

This application is based on and claims priority to Japanese Patent Application No. 2023-054110, filed on Mar. 29, 2023, the entire contents of which are incorporated herein by reference.

### REFERENCE SIGNS LIST

400 Inspection system
410 AOI device
440 Training apparatus
441 Training dataset generation unit
442 Training unit
630 Training dataset
710 Image input unit
720 Masking unit
730 Image reconstructing unit
740 Comparing and changing unit
810 Determination apparatus
811 Inference unit
812 Output unit
1000 Input image dataset
1010 Image input unit
1020 Masking unit
1030 Trained image reconstructing unit
1040 Removal unit
1050 Determination unit

1. A determination apparatus, comprising:
a processor configured to:
use a trained image generation AI trained so as to reconstruct a first image from a first mask image in which a mask is overlaid onto an inspection region of the first image, the mask being colored according to types of material included in a corresponding region of an inspection target object and being configured to be overlaid onto the inspection region, the first image being an image determined not to contain a defect among captured images of the inspection target object; and
compare a second reconstruction image with a second image to determine whether or not the second image contains a defect, the second reconstruction image being reconstructed by inputting a second mask image into the trained image generation AI, the second mask image being an image in which the mask is overlaid on, and corresponds to, an inspection region of the second image, the second image being a captured image of the inspection target object.

2. The determination apparatus according to claim 1, the processor is further configured to:
generate both a post-removal second image in which a region including specific types of material is removed from the second image and a post-removal second reconstruction image in which a region including specific types of material is removed from the second reconstruction image;
wherein the processor determines whether or not the second image contains a defect by comparing the post-removal second image with the post-removal second reconstruction image.

3. The determination apparatus according to claim 2, wherein
the processor
determines that the second image does not contain a defect in a case where a value calculated based on an error of pixel values of corresponding pixels between the post-removal second image and the post-removal second reconstruction image satisfies a predetermined condition, and
determines that the second image contains a defect in a case where the value calculated based on the error of pixel values of corresponding pixels between the post-removal second image and the post-removal second reconstruction image does not satisfy the predetermined condition.

4. The determination apparatus according to claim 1, wherein the mask to be overlaid onto the first image is CAD data, of a region corresponding to the inspection region of the first image, extracted from CAD data of the inspection target object, and is colored by identifying types of material included in the corresponding region of the inspection target object.

5. The determination apparatus according to claim 4, wherein when the region corresponding to the inspection region of the first image is extracted from the CAD data of the inspection target object, the CAD data of the inspection target object is corrected in both position and size according to the first image.

6. The determination apparatus according to claim 1, wherein the mask to be overlaid onto the second image is CAD data, of a region corresponding to the inspection region of the second image, extracted from CAD data of the inspection target object, and is colored by identifying types of material included in the corresponding region of the inspection target object.

7. The determination apparatus according to claim 6, wherein when the region corresponding to the inspection region of the second image is extracted from the CAD data of the inspection target object, the CAD data of the inspection target object is corrected in both position and size according to the second image.

8. A training apparatus, comprising:
a processor configured to:
generate a first mask image by overlaying a mask onto an inspection region of a first image, the mask being colored according to types of material included in a region corresponding to an inspection target object and configured to be overlaid onto the inspection region of the first image, the first image being an image determined not to contain a defect among captured images of the inspection target object; and
use an image generation AI to output a first reconstruction image in a case where the first mask image is input into the image generation AI,
wherein the image generation AI is trained such that first reconstruction image more closely resembles the first image.

9. A determination method executed by a computer of a determination apparatus storing therein a trained image generation AI that is trained so as to reconstruct a first image from a first mask image in which a mask is overlaid onto an inspection region of the first image, the mask being colored according to types of material included in a corresponding region of an inspection target object and being configured to be overlaid onto the inspection region, the first image being an image determined not to contain a defect among captured images of the inspection target object, the determination method comprising:
comparing a second reconstruction image with a second image to determine whether or not the second image contains a defect, the second reconstruction image being reconstructed by inputting a second mask image into the trained image generation AI, the second mask image being an image in which the mask is overlaid on, and corresponds to, an inspection region of the second image, the second image being a captured image of the inspection target object.

10. A training method executed by a computer of a training apparatus, the training method comprising:
generating a first mask image by overlaying a mask onto an inspection region of a first image, the mask being colored according to types of material included in a region corresponding to an inspection target object and configured to be overlaid onto the inspection region of the first image, the first image being an image determined not to contain a defect among captured images of the inspection target object; and
outputting, by an image generation AI, a first reconstruction image, in a case where the first mask image is input into the image generation AI,
wherein in the outputting, training processing is performed on the image generation AI such that the first reconstruction image more closely resembles the first image.

11. A computer-readable non-transitory recording medium storing therein a determination program for causing a computer in a determination apparatus storing therein a trained image generation AI, trained so as to reconstruct a first image from a first mask image in which a mask is overlaid onto an inspection region of the first image, the mask being colored according to types of material included in a corresponding region of an inspection target object and being configured to be overlaid onto the inspection region, the first image being an image determined not to contain a defect among captured images of the inspection target object, to:
compare a second reconstruction image with a second image to determine whether or not the second image contains a defect, the second reconstruction image being reconstructed by inputting a second mask image into the trained image generation AI, the second mask image being an image in which the mask is overlaid on, and corresponds to, an inspection region of the second image, the second image being a captured image of the inspection target object.

12. A computer-readable non-transitory recording medium storing therein a training program causing a computer in a training apparatus to execute:
generating of a first mask image by overlaying a mask onto an inspection region of a first image, the mask being colored according to types of material included in a region corresponding to the inspection target object and configured to be overlaid onto the inspection region of the first image, the first image being an image determined not to contain a defect among captured images of the inspection target object; and
outputting, by an image generation AI, a first reconstruction image, in a case where the first mask image is input into the image generation AI,
wherein in the outputting, training processing is performed on the image generation AI such that the first reconstruction image more closely resembles the first image.
